(19) United States
(12) Patent Application Publication
(10) Pub. No.: US 2012/0253707 A1
(43) Pub. Date: Oct. 4, 2012

(54) Device and Method for Quantifying and Analyzing the State of Damage in a Solid Medium

(76) Inventor: Gang Qi, Memphis, TN (US)

(21) Appl. No.: 13/279,243

(22) Filed: Oct. 21, 2011

Related U.S. Application Data
(60) Provisional application No. 61/405,222, filed on Oct. 21, 2010.

(51) Int. Cl. G06F 19/00

(52) U.S. Cl. 702/56

(57) ABSTRACT

A device and method for assessing the damage state of solid materials and structures subjected to loading. The device includes multiple AE sensors connected to the switch controller/Amplifier/AD convertor, the event sorting module, the spectrum assignment unit, the probability space resolver, the trajectory of damage state generator, power source, and a visual display. The method includes means to assess and analyze performance of solid materials and structures that accounts for the influence of microscopic random damage events statistically, the method including the steps of sorting the electric signals into a series of non-overlapping AE events; determining the spectra of the sorted events; computing the probability distribution of the spectra; computing the probabilistic entropy of the probabilistic distribution; and generating the trajectory of damage state.

### CROSS-REFERENCE TO RELATED APPLICATIONS

This application claims the benefit of U.S. Provisional Application No. 65/405,222, filed Oct. 21, 2010.

### BACKGROUND OF THE INVENTION

The modern day acoustic emission devices and techniques (AE) are applied widely to characterize and evaluate the performances of materials and structures in general. The major complication involved in these applications is that the occurrence of various damage events and mechanisms is highly stochastic as the loads progress, and as the service life of the materials and structures proceeds. Presently, various features of the electric signals have been used such as the amplitude, energy, frequency, duration, rise time, number of signal counts (ring-down counts), number of event, and waveform acquired by AE sensors. For instance, the accumulative AE events, event amplitude and energy were used to correlate with crack development; frequency spectrum of AE waves were used to correlate with various failure mechanisms of composite materials, and the number of AE counts were used to indicate the intensity of damage. The ultimate purpose of using these features is to reveal the interconnections between the random damage and variations of material properties under applied stress.

The key point of interest of the mentioned interconnections is that damage and material inherent structure are complementary to each other under such a circumstance. Damage field once generated is irreversible, and weakens the integrity of the material's inherent structure. The presence of damage field results in a re-allotment of the applied stress field. The re-allotted stress field in turn escalates the damage process that further weakens the integrity of the inherent structure resulting in new re-allotment of the stress field. The interactions between the damage and stress fields become eventually a series of continuous interconnected processes that contribute to the ultimate rapture of the materials.

In these processes, the responses of the inherent structure of the material to the variations of the applied stress are highly stochastic, which complicates the efforts to characterize and evaluate the mechanical performance of materials and structures, thus, a method and device that is capable of accounting for the stochasticity becomes essential. The present AE techniques do not possess such a capability; presently, the corresponding efforts were unable to reveal the statistics associated with the stochastic nature involved in the aforementioned processes, thus, failed to account for the statistical significance when using the AE signatures in the evaluation and characterization of the mechanical performance of solids, despite the advancements of AE techniques in the past decades. Therefore, a novel method and device are in much need.

### SUMMARY OF THE INVENTION

The present invention provides a novel method and device for assessing material damage resulted from micro- and meso-structural variations by measuring acoustic signals of randomly generated microscopic events (RGME). The present invention includes a damage state monitoring and analyzing device that includes an event sorting module (ESM), a spectrum assignment unit (SAU), a probability space resolver (PSR), and a trajectory of damage state (TDS) generator. The purpose of ESM is to sort the signals due to damage into a series of events in the order of the applied load, displacement, pressure, temperature, and or time sequence according to the interests of study. The purpose of SAU is to determine the spectra of the sorted damage events. The purpose of PSR to estimate the probability spaces of the determined spectra; and the TDS generator is used to compute the probabilistic entropy that further is correlated to the applied load, displacement, pressure, temperature, and/or time whenever it is appropriate to determine the trajectory of damage state.

The present invention further includes a method for monitoring and analyzing the state of irreversible damage consisting of the steps of providing a monitoring and analyzing device that conducts and executes the algorithms to obtain the spectrum, the probability space, and the trajectory of random damage events from acquired AE signatures.

The novelty of the present invention is: 1) it takes into account the interconnections between the permanent damage and the material inherent structure under the actions of applied stress; 2) it resolves the aforementioned complications in a statistical manner by providing an ensemble average of the multi- and trans-scale permanent damage under the actions of applied stress; and 3) it provides high resolution results.

The present invention is applicable to the assessment of the responses of random damage to the applied stress to the solid medium of all load-bearing structures of machineries and infrastructures and other similar structures.

### BRIEF DESCRIPTION OF THE DRAWINGS

The invention is illustrated by the accompanying drawings, in which:

FIG. 1 is the schematic diagram of an AE system

FIG. 2 shows the block diagram of a damage state monitoring and analyzing device of the present invention.

FIG. 3 is an embodiment that includes the principle circuitry of the SAU, PSR and TDS.

FIG. 4a is an example energy spectrum.

FIG. 4c is an example duration spectrum.

FIG. 4d is an example rise time spectrum.

FIG. 4d is an example amplitude spectrum.

FIG. 5a is an example probability space of energy.

FIG. 5b is an example probability space of duration.

FIG. 5c is an example probability space of rise time.

FIG. 5d is an example probability space of amplitude.

FIG. 6a is an example TDS of energy vs applied stress.

FIG. 6b is an example TDS of duration vs applied stress.

FIG. 6c is an example TDS of rise time vs applied stress.

FIG. 6d is an example TDS of amplitude vs applied stress.

FIG. 7a is an example TDS of energy vs time.

FIG. 7b is an example TDS of duration vs time.

FIG. 7c is an example TDS of rise time vs time.

FIG. 7d is an example TDS of amplitude vs measuring time.

### DETAIL DESCRIPTION OF THE PREFERRED EMBODIMENTS

The present invention comprises the methods, a device, and product useful in detecting and assessing the acoustic emission (AE) signals to reveal the significance of the interconnections between the features of these signals with the occurrence of random damage events and mechanisms statistically. This invention orchestrates AE signatures of single or multiple AE sensors to attain the statistics of the stress/strain waves that trigger the AE signatures, and to deliver the result in a simple manner by a limited data acquisition system. Our invention is applicable to utilization such as the characterization and evaluation of materials, and engineering structural health monitoring.

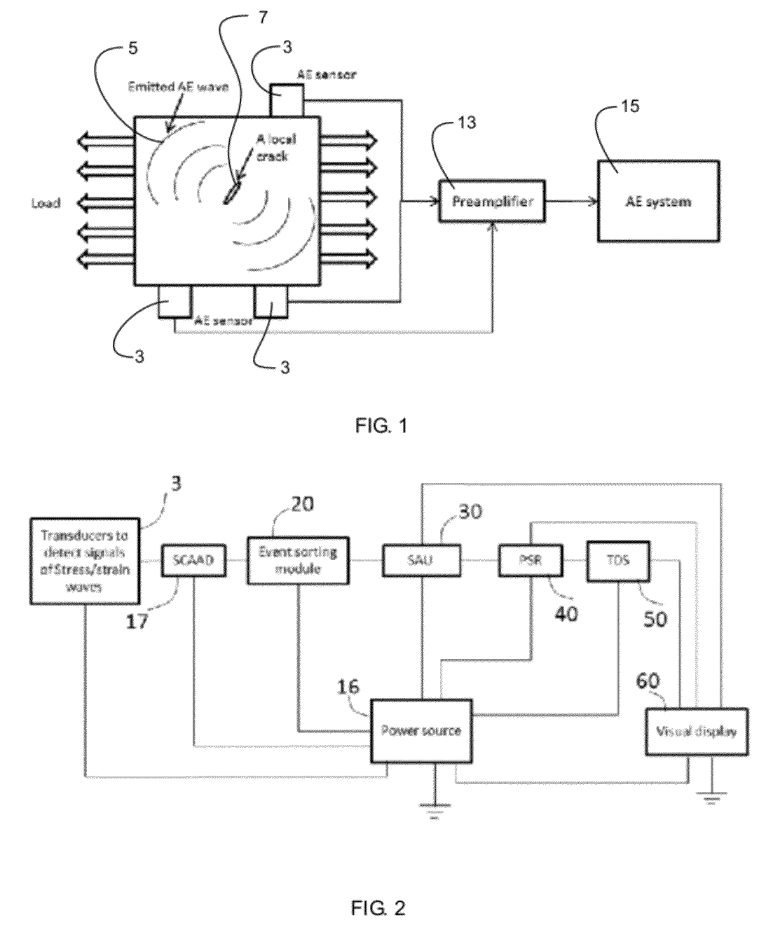

FIG. 1 is the schematic diagram of general working process of an AE system: a solid 1 will emit signals 5 when permanent damage 7 occurs due to loading of the solid 7. The loading may be an applied load of a known magnitude, or a load of an unknown magnitude. AE sensors 3 are attached to the structure 1 to pick up the signals 5. The signals 5 are emitted volumetrically detected by the AE sensors 3 that are attached to the surface of the solid 1. These signals 5 are pre-amplified by a preamplifier 13 first, and then fed to an AE system 15 for succeeding processes.

FIG. 2 shows a block diagram of the damage state monitoring and analyzing comprising: an event sorting module (ESM) 20, a spectrum assignment unit (SAU) 30, a probability space resolver (PSR) 40, and a trajectory of damage state (TDS) generator 50. The purpose of ESM 20 is to sort the signals due to damage into a series of events in the order of the applied load, displacement, pressure, temperature, and/or time sequence according to the interests of study. The purpose of SAU 30 is to determine the spectra of the sorted damage events. The purpose of PSR 40 to estimate the probability spaces of the determined spectra; and the TDS generator 50 is used to compute the probabilistic entropy that further is correlated to the applied load, displacement, pressure, temperature, and/or time whenever it is appropriate to determine the trajectory of damage state.

Damage for the purposes of the present invention comprise irreversible events such as the nucleation of tiny cracks, their coalescence; deformation, fractures, ruptures of various length scales of a solid medium that are detectable by the AE sensors 3. These events can either be purposefully generated to expose the damage mechanisms of the solid, i.e., testing and evaluation of the solids, or those are unintended and unforeseen in most common applications, including the failures of structural materials such as oil pipes, bridge girders, airplane wings and landing gears, and many other structures subjected to loads.

The device of the present invention examines the acoustic signature of the solid structure under the predetermined triggering criteria to activate the recording of the occurrence of irreversible damage to the solid structure by switch controller/amplifier/AD converter 17. The device is triggered by an event comprises an acoustic signal at a predetermined threshold, e.g., amplitude. Once an acoustic triggering event occurs, it is recorded to be an element of a certain column of a data matrix according to the magnitude of this AE signature by event sorting module 20. Since an acoustic triggering event may be detectable by more than one sensors, a predetermined sorting mechanism will function, first, to resolve those signatures detected by multiple sensors to determine whether they are generated by the same source; then, the selected representative signature is recorded in the same manner to be an element of a certain column of the data matrix as mentioned above by event sorting module 20.

The above process is repeated as the data acquisition proceeds as such a data matrix will be constructed to establish a spectrum of the AE signatures by spectrum assignment unit 30. This matrix can be comprised of the amplitude, energy, rise time, and duration of the AE signatures depending on the interests of applications. For instance, when the matrix is established in terms of the amplitude of the AE signatures, an amplitude spectrum matrix is established; and an energy spectrum matrix is formed when the energy of the AE signatures is employed.

When each row of a spectrum is normalized by probability space resolver 40, the data matrix becomes an approximation of the corresponding probability space that reveals the occurring probability of certain AE signature.

The probabilistic entropy is computed using the probability space. The variations of this entropy are associated with the variations of the state of damage. This scalar quantity is an ensemble average of the statistics of all recorded tiny damage events which may vary from nano- to macro-scale. When the applied stress is available, particularly, the curve of probabilistic entropy versus the applied stress is defined as the trajectory of damage state (TDS) generated by TDS generator 50. In a TDS curve, the variations of this entropy are capable of revealing the macroscopic performance that is specifically capable of taking into account the effects of variations of microstructures of solids.

FIG. 2 shows a block diagram of the preferred embodiment of the invention. In this embodiment the invention consists of multiple AE sensors 3 connected to the switch controller/Amplifier/AD convertor (SCAAD) 17, the event sorting module (ESM) 20, the spectrum assignment unit (SAU) 30, the probability space resolver (PSR) 40, the trajectory of damage state generator (TDS) 50, a power source 16, and a visual display 60.

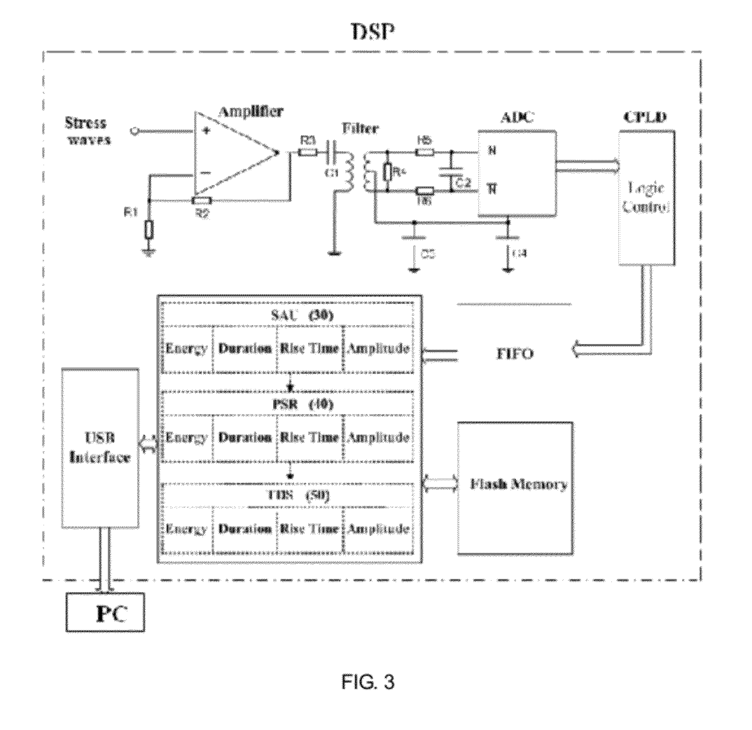

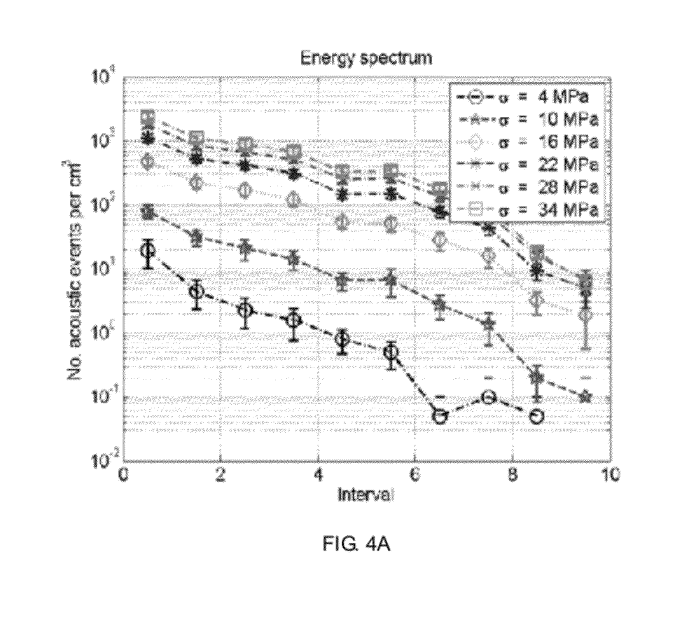

FIG. 3 shows principle circuitry of an embodiment of the invention as used with a Digital Signal Processor (DSP) showing the spectrum assignment unit (SAU) 30, the probability space resolver (PSR) 40, the trajectory of damage state generator (TDS) 50.

In one embodiment of the invention the following analysis occurs: Let x denote:

1. the energy;

2. the duration; or

3. the rise time of a detected acoustic event (signal).

The range of x is determined by maximum xₘₐₓ−minimum xₘᵢₙ. X is then divided into N subintervals: each of them is between xₘᵢₙ+Δx(i−1) and xₘᵢₙ+Δx(i), where Δx is the increment, and i=1 . . . N. The value of N is dependent on the denotation of x to be either the energy, the duration, or the rise time of the acoustic event, and dependent also on the analytical interests of the results so that N can be of 5, 10, 100, 1000, or any limited integer for the expected resolution.

Let D be data matrix:

D:=[βᵢⱼ]_{M×N}

where M is the index that depends on the means to obtain the x statistics, and N is number of subintervals that divides the x bandwidth that it holds the divided x values. Let βᵢⱼ be the measured quantity of x from 0−i which falls in the j^{th} sub-interval observed up to a measured level (specific load or time level), such that

$${β}_{ij} = {\sum }_{m = 1}^{i} {x}_{mj}$$

$$for i = 1 , … , M and j = 1 , … , N$$

Data matrix D will grow or accumulate with either the increasing amount of load or timing of the tests as the loading level increases or time passes during testing. Each row of the D data matrix is a measurement interval. Each row of D data matrix is summed, and each value of the row is divided by the summation to obtain a normalized D matrix such that it is an approximated probability distribution of the detected acoustic event x in terms of the energy, duration, or rise time of this event.

This multi-component D variate is designated to be a descriptor of damage field, and denote it physically to be the state of damage of materials subjected to loads. In other words, material damage state is a physical quantity that implies knowing a spectrum or the probability distribution of detected acoustic signal. This spectrum can be the energy, the duration, or the rise time of the detected acoustic signals.

The state of damage may be described by probabilistic entropy. The severity of the damage may be characterized by the entropy (s) of the probability distribution of the measured characteristics of the observed acoustic signals. The probabilistic entropy quantifying this state of damage may be described as,

$$S \approx {s}_{i} := {\sum }_{j = 1}^{10} {f}_{ij} ln ( 0.1 / {f}_{ij} ) for i = 1 , … , T$$

The current invention evaluates the macroscopic performance of materials while overcoming complicating factors such as the different structural features, various length scales and the stochastic responses of these structures to the applied stress by establishing a framework of interactive stress and damage fields. To describe the damage field, the damage state is defined by all possible modes of irreversible damage to the microstructures that are generated within a unit volume of a body. To quantify the damage state, a multi-component variate is constructed in terms of the amplitude spectrum or the Gibbs probability distribution of acoustic signals. The Gibbs probability distribution can be further summarized by probabilistic entropy.

### EXAMPLE

We sort the acquired AE signals to events that eliminates duplications, and assign the sorted events into the spectra in such a way that according to magnitudes of the energy, duration, rise time, and amplitude of the random damage events (RDE) sorted into corresponding AE signatures,

D̅=[βᵢⱼ]_{M×N} (1)

where M indexes the sequence of the external conditions associated with RDE. N is the number of subintervals that divides the bandwidth of AE signals' energy, duration, and rise time. For example, if the applied load is the external condition, M indexes the loading sequence. D is normalized to approximate the corresponding probability space, D̅,

D̅::=[fᵢⱼ]_{M×N} (2)

where

$${f}_{ij} = \frac{{β}_{ij}}{{L}_{i}} for i = 1 , … , M \qquad ( 3 )$$

In Eq. 3, βᵢⱼ be the quantity of RDE from 0−i whose energy, duration, rise time and amplitude fall in the jth sub-interval, and is

$${β}_{ij} = {\sum }_{m = 1}^{i} {x}_{mj} \\ for i = 1 , … , M and j = 1 , … , N \qquad ( 4 )$$

and xᵢ is an sorted AE event, normalized by the volume of the gauge section of the specimen measured in the interval of (i−1, i), and Lᵢ is,

$${L}_{i} = {\sum }_{m = 1}^{i} {\sum }_{j = 1}^{N} {x}_{mj} for i = 1 , … , M \qquad ( 5 )$$

The hardware of SAU and PSR remain active to receive sorted RDE by ESM 20. The stored two-dimensional data array from both SAU and PSR are displayed at 60 for quantitative multi, and trans-scale coupling analysis.

TDS 50 takes the data of two-dimensional array D̅ and determines the probabilistic entropy,

$$S \approx {s}_{i} := {\sum }_{j = 1}^{10} {f}_{ij} ln ( 0.1 / {f}_{ij} ) for i = 1 , … , T \qquad ( 6 )$$

When correlated with external parameters such as applied load, displacement, pressure, and or temperature, trajectory of damage state (TDS) is obtained in terms of these parameters to reveal probabilistic characteristics of stochastic random damage events. When the above parameters are not available (too difficult to acquire), TDS is equated simply with the period of time of measurements, and consistent characteristics can still be achieved.

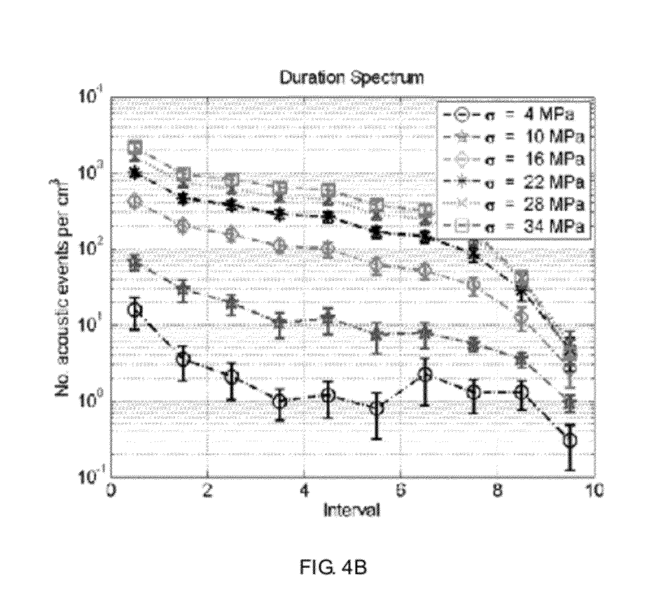

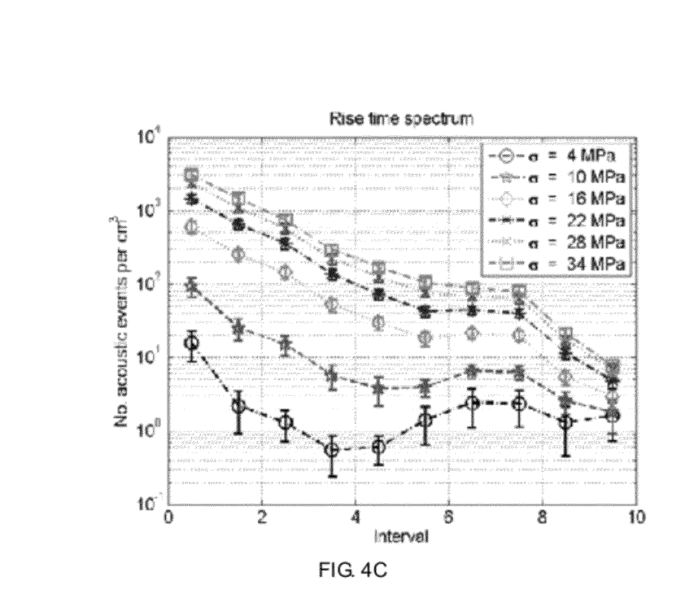

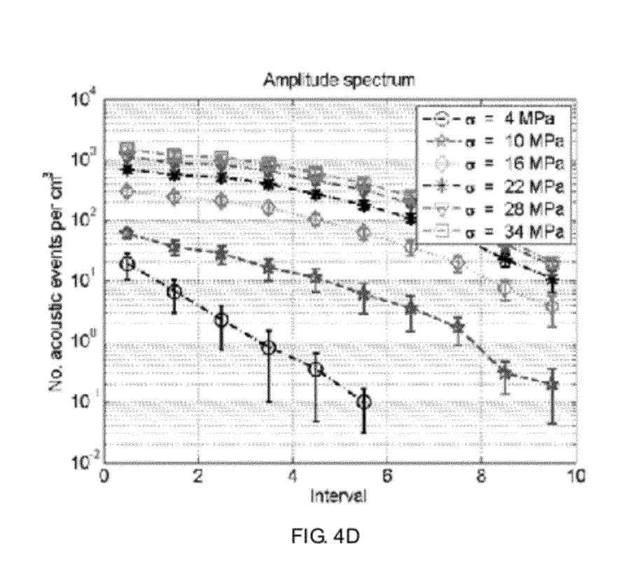

The spectra of energy, duration, rise time, and amplitude of a sample PMMA bone cement material are given in FIG. 4a thru FIG. 4d.

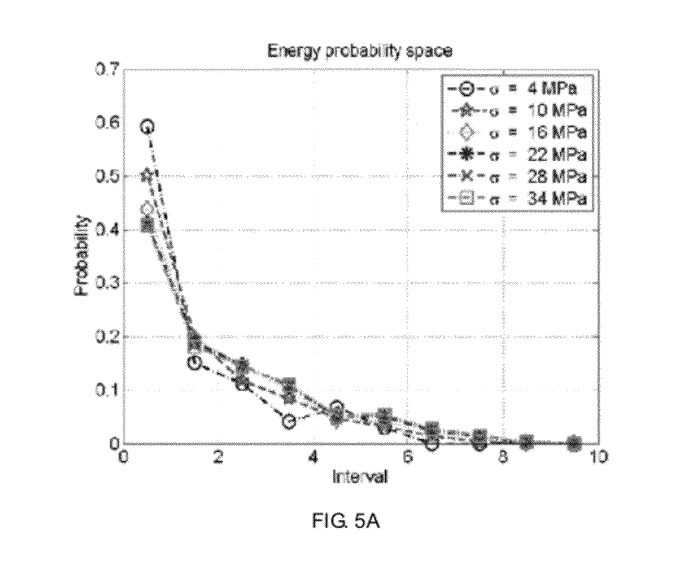

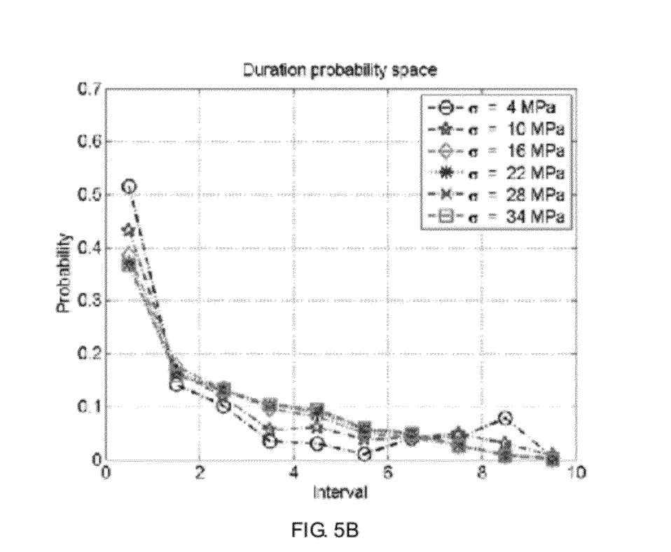

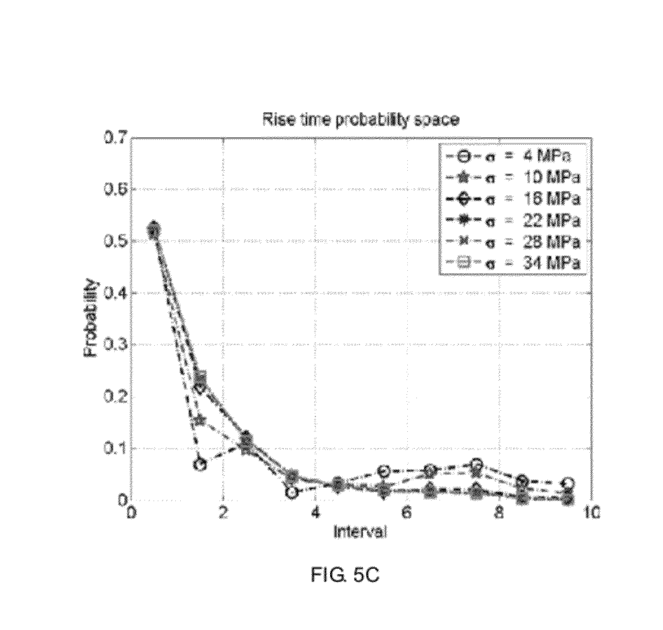

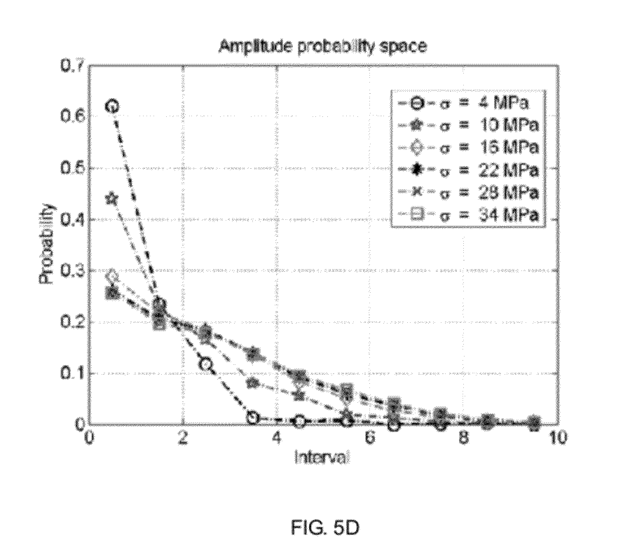

The probability spaces of the spectra of energy, duration, rise time, and amplitude of a sample PMMA bone cement material are given in FIG. 5a thru FIG. 5d.

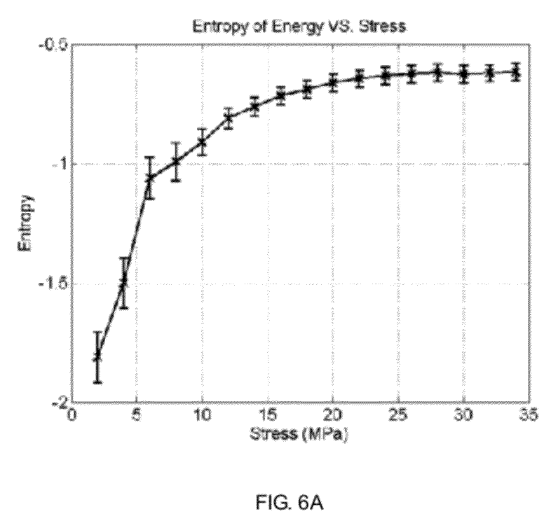

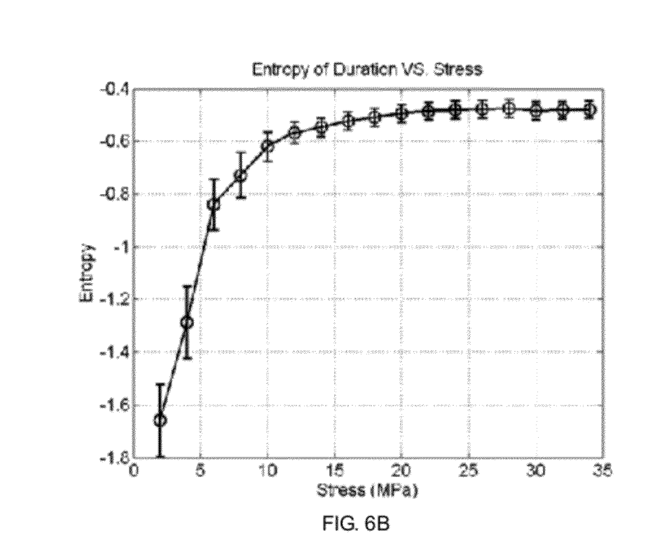

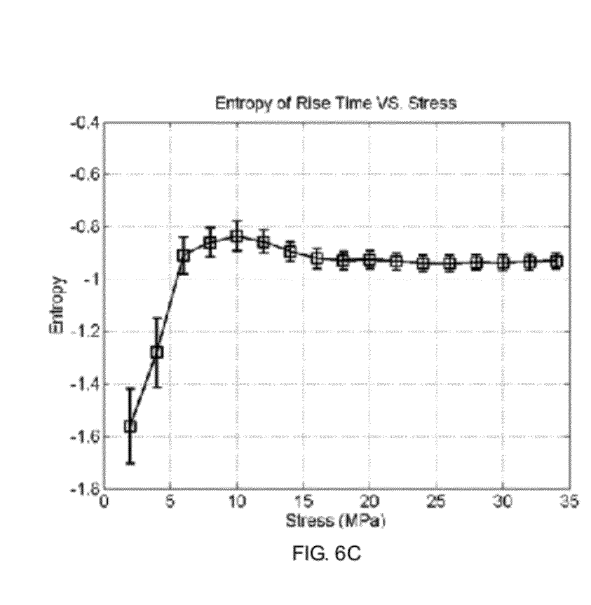

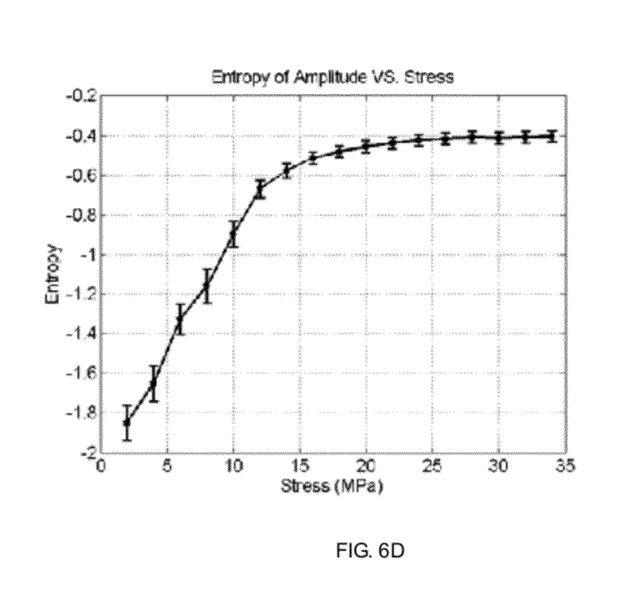

The damage state trajectories, TDS, with respect to applied stress of a sample PMMA bone cement material are given in FIG. 6a thru FIG. 6d for the entropies of energy, duration, rise time, and amplitude, respectively.

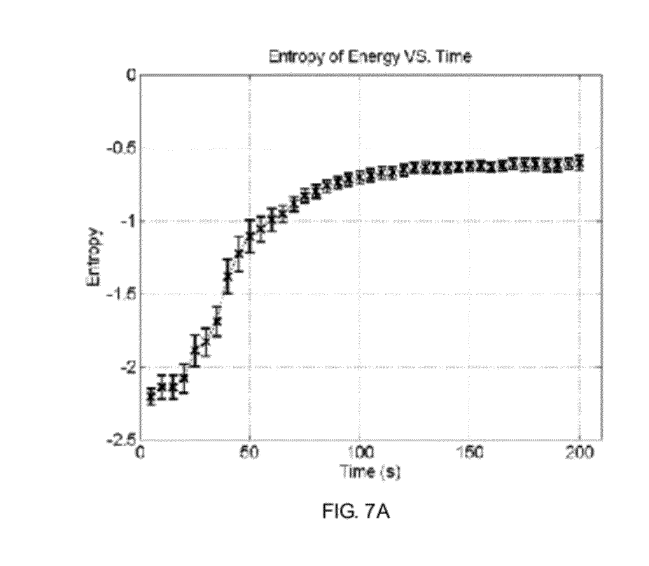

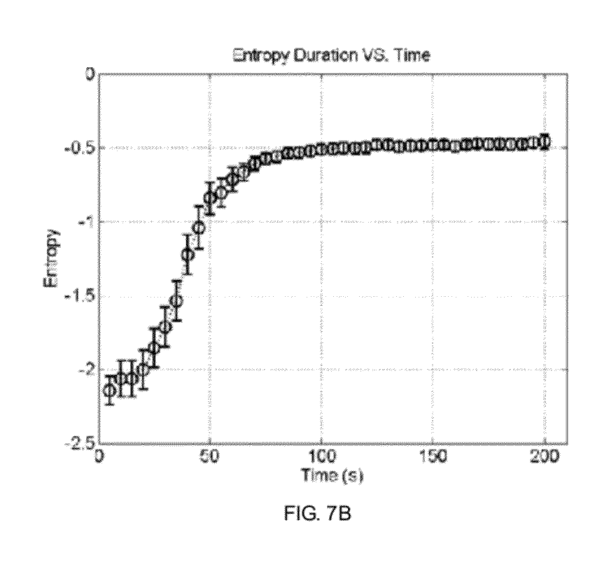

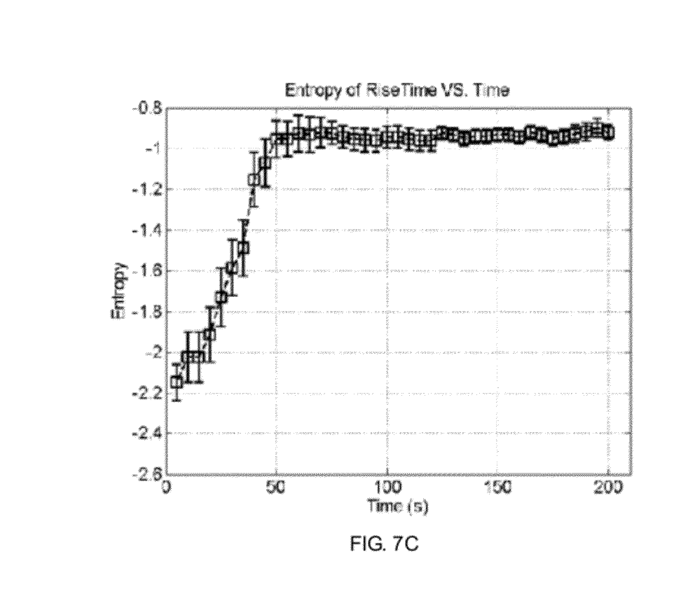

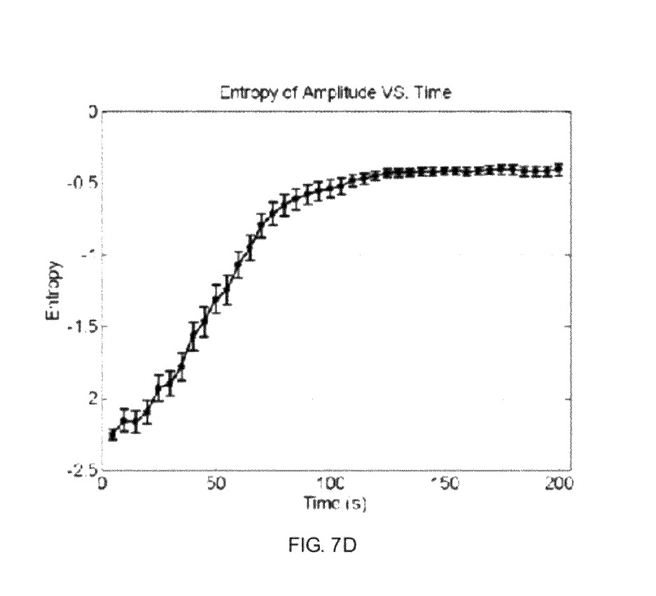

The damage state trajectories, TDS, with respect to measuring time of a sample PMMA bone cement material are given in FIG. 7a thru FIG. 7d for the entropies of energy, duration, rise time, and amplitude, respectively.

We claim:

1. A device for assessing and analyzing performance of solid materials and structures, the preferred embodiment of said device comprising:
(a) acoustic emission sensors;
(b) switch controller/Amplifier/AD convertor;
(c) event sorting module;
(d) spectrum assignment unit;
(e) probability space resolver; and
(f) trajectory of damage state generator.

2. The device of claim 1, wherein said event sorting module sorts a plurality of damage events.

3. The device of claim 1, wherein said spectrum assignment unit determines a damage event spectra.

4. The device of claim 1, wherein said probability space resolver computes a probability distribution.

5. The device of claim 1, wherein said trajectory of damage state generator computes said probabilistic entropy.

6. A method assessing and analyzing performance of solid materials and structures that accounts for the influence of microscopic random damage events statistically, said method comprising the steps of:
(a) sorting the electric signals into a series of non-overlapping acoustic emission events;
(b) determining the spectra of said sorted events;
(c) computing the probability distribution of said spectra;
(d) computing the probabilistic entropy of said probabilistic distribution; and
(e) generating the trajectory of damage state.

7. The method of claim 6, wherein the step of sorting the electric signals into a series of non-overlapping acoustic emission events includes sorting said damage events with respect to one or more parameter belonging to the group consisting of: applied load; displacement; pressure; temperature; and time sequence, according to the interests of applications.

8. The method of claim 6, wherein determining the spectra of said sorted events step includes the determination of said spectrum of said sorted events with respect to one or more parameter belonging to the group consisting of: applied load; displacement; pressure; temperature; and time sequence, according to the interests of applications.

9. The method of claim 6, wherein computing the probability distribution of said spectra, includes the computation of said spectrum with respect to one or more parameter belonging to the group consisting of: applied load; displacement; pressure; temperature; and time sequence, according to the interests of applications.

10. The method of claim 6, wherein computing the probabilistic entropy of said probabilistic distribution step includes the computation of said probabilistic entropy of said probabilistic distribution in terms of one or more parameter belonging to the group consisting of: applied load; displacement; pressure; temperature; and time sequence, according to the interests of applications.

11. Method of claim 6, wherein generating the trajectory of damage state step includes the generating said trajectory of damage state in terms of one or more parameter belonging to the group consisting of: applied load; displacement; pressure; temperature; and time sequence, according to the interests of applications.

12. The method of claim 8, wherein said spectrum is a 2D data matrix of acoustic emission signatures, is spectrum data matrix.

13. The method of claim 12 wherein said spectrum data matrix possesses a column and a row, said column is subinterval of measurements, said row is the increment of sampling of one or more parameter belonging to the group consisting of: applied load; displacement; pressure; temperature; and time sequence, according to the interests of applications.

14. The method of claim 9 wherein said probabilistic distribution is a row normalized of said spectrum data matrix.

15. The method of claim 10 wherein said probabilistic entropy according is computed row by row of said probabilistic distribution data matrix.

16. The method of claim 12 wherein said trajectory of damage state is the presentation of probabilistic entropy versus one or more parameter belonging to the group consisting of: applied load; displacement; pressure; temperature; and time sequence according to the interests of applications.

17. A method for the assessment of the state of damage of a mechanically loaded material by measuring acoustic signals of randomly generated acoustic events, comprising the steps:
placing at least one acoustic event sensor on a surface of said material;
recording said acoustic signals;
creating a variate of acoustic emission data representing the spectrum of a randomly generated microscopic event characteristic selected from the group consisting of energy, duration and rise-time;
quantifying the spectrum using Gibbs probabilistic entropy; and
correlating said probabilistic entropy with the applied stress to obtain an entropy—stress relationship; and
assessing the damage state of said material from said entropy values of said entropy—stress relationship.

18. The method of claim 17 wherein said variate is a two-dimensional variate comprised of a first dimension consisting of sub-intervals of a known driving condition selected from the group consisting of time, stress, strain, force, displacement and pressure.

19. The method of claim 17 wherein said variate is a two-dimensional variate comprised of a second dimension consisting of sub-intervals of said recorded acoustic signals.

20. The method of claim 17 wherein said probabilistic entropy is approximated

21. A method for the assessment of the state of damage of a material by analyzing the acoustic events recorded during mechanical loading of a material, comprising the steps:
creating a variate of acoustic emission data representing the spectrum of a randomly generate microscopic event characteristic selected from the group consisting of energy, duration and rise-time;
quantifying said spectrum using Gibbs probabilistic entropy;
correlating said probabilistic entropy with the applied stress to obtain an entropy—stress relationship; and
assessing the damage state of said material from said entropy values of said entropy—stress relationship.
